(19) United States
(12) Patent Application Publication
(10) Pub. No.: US 2016/0091344 A1
(43) Pub. Date: Mar. 31, 2016

(54) CAPACITIVE TRANSDUCER AND METHOD OF MANUFACTURING THE SAME, AND OBJECT INFORMATION ACQUIRING APPARATUS

(71) Applicant: CANON KABUSHIKI KAISHA, Ohta-ku, Tokyo (JP)

(72) Inventors: Yoshihiro Hasegawa, Hiroshima-shi (JP); Toshio Tomiyoshi, Yokohama-shi (JP)

(73) Assignee: CANON KABUSHIKI KAISHA, Ohta-ku, Tokyo (JP)

(21) Appl. No.: 14/890,718

(22) PCT Filed: May 29, 2014
(86) PCT No.: PCT/JP2014/064895

§ 371 Date: Nov. 12, 2015

(30) Foreign Application Priority Data
Jun. 7, 2013 (JP) 2013-120666

(51) Int. Cl. G01D 5/24; G01N 29/24

(52) U.S. Cl. CPC G01D 5/24; G01N 29/2418; G01N 2291/101

(57) ABSTRACT

Provided is a capacitive transducer with improved reliability of sealing. The capacitive transducer includes a cell and a sealing portion. The cell includes a first electrode and a vibrating membrane having a second electrode formed to oppose the first electrode through intermediation of a cavity. An etching opening portion is formed to form the cavity by sacrifice layer etching. The sealing portion seals the etching opening portion. A gap at a periphery of the sealing portion has a height smaller than that of the cavity. In a manufacturing method therefor, in a step of forming a sacrifice layer for forming the cavity and the gap communicating to the cavity via an etching flow path, a height of the sacrifice layer in a region that is to become the gap is set to be smaller than that of the sacrifice layer in a region that is to become the cavity.

### TECHNICAL FIELD

The present invention relates to a capacitive transducer to be used as an ultrasonic transducer or the like, a method of manufacturing the capacitive transducer, and an object information acquiring apparatus.

### BACKGROUND ART

With recent advancement of micromachining technology, various kinds of micromechanical elements processed with an accuracy level of micrometer order have been realized. With use of this technology, development has been actively made on a capacitive transducer (capacitive micromachined ultrasonic transducer: CMUT). The CMUT is an ultrasonic device configured to vibrate a lightweight vibrating membrane to transmit and receive (at least one of transmission or reception) acoustic waves such as ultrasonic waves (hereinafter sometimes represented by “ultrasonic waves”). CMUTs having excellent broadband characteristics also in liquid and air can easily be obtained. Therefore, the use of CMUTs for medical applications enables a more accurate diagnosis than the use of a hitherto used ultrasonic device including a piezoelectric element, and hence the CMUTs are attracting attention as an alternative thereto. Note that, the acoustic waves as used herein include sound waves, ultrasonic waves, and photoacoustic waves. For example, the acoustic waves include a photoacoustic wave that is generated inside an object when the inside of the object is irradiated with light (electromagnetic wave) such as a visible ray and an infrared ray.

The capacitive transducer has, for example, a cell structure including a first electrode formed on a substrate made of Si or the like, a second electrode formed to oppose the first electrode through intermediation of a gap (cavity), a vibrating membrane made of a membrane, which includes the second electrode and is formed above the cavity, and a vibrating membrane support portion. Then, the membrane has a structure of sealing the cavity. One method of manufacturing the capacitive transducer is to form a capacitive transducer by stacking materials on a substrate made of Si or the like. The cavity structure is formed by depositing a sacrifice layer material in advance in a region that is to become a gap and removing a sacrifice layer by etching through an opening portion (etching opening portion) formed in a part of the vibrating membrane. The capacitive transducer may sometimes be used in liquid such as water and oil. In a transducer configured to transmit and receive ultrasonic waves by vibration of the vibrating membrane, when such liquid infiltrates the cavity, vibration characteristics of the vibrating membrane may deteriorate. Accordingly, the etching opening portion formed for forming the cavity needs to be sealed before use.

In a capacitive transducer disclosed in Non Patent Literature 1, a silicon nitride film formed by LP-CVD is deposited in a flow path communicating from an etching opening portion to a cavity located under a vibrating membrane, to thereby seal the cavity. LP-CVD stands for low-pressure chemical vapor deposition. In LP-CVD, because of the nature of the apparatus, the film is deposited to have a substantially uniform thickness in regions from the etching opening portion to the cavity via the flow path, and when the film is deposited by the height of the flow path, the cavity is sealed. Accordingly, by reducing the height of the flow path communicating from the etching opening portion to the cavity, the sealing of the cavity is facilitated to improve sealing performance. Note that, the “height” as used herein means a width in a direction perpendicular to the substrate. The height is sometimes referred to as “thickness” when no misunderstanding occurs.

Also in a capacitive transducer disclosed in Patent Literature 1, similarly to Non Patent Literature 1, a cavity is formed by removing a sacrifice layer through an etching opening portion. In addition, a film is deposited in the etching opening portion by plasma-enhanced chemical vapor deposition (PE-CVD), to thereby seal the cavity. In PE-CVD, the film hardly enters the inside of the cavity and the flow path unlike LP-CVD, but the film is formed so as to be deposited in a region of the etching opening portion. Accordingly, in order to seal the cavity, it is necessary to deposit a sealing film to have a sufficiently larger height than the height of the cavity.

### CITATION LIST

### Patent Literature

PTL 1: U.S. Pat. No. 5,982,709

### Non Patent Literature

NPL 1: Arif Sanli Ergun et al. IEEE Transactions on Ultrasonics, Vol. 52, No. 12, DECEMBER 2005, 2242-2257

### SUMMARY OF INVENTION

### Technical Problem

A sealing portion for sealing the cavity of the capacitive transducer needs a film whose thickness is approximately three times as large as the height of the cavity. Accordingly, as the height of the cavity becomes larger, the necessary height or thickness of the sealing portion becomes larger to reduce the reliability of sealing.

### Solution to Problem

In view of the problem described above, according to one embodiment of the present invention, there is provided a capacitive transducer, including: a cell having a first electrode, and a vibrating membrane including a second electrode, the second electrode being formed to oppose the first electrode through intermediation of a cavity; and a sealing portion for sealing an etching opening portion, the etching opening portion being formed by sacrifice layer etching in order to form the cavity, in which a gap at a periphery of the sealing portion has a height smaller than a height of the cavity.

Further, in view of the problem described above, according to one embodiment of the present invention, there is provided a method of manufacturing a capacitive transducer, the capacitive transducer including a cell and a sealing portion, the cell including a first electrode and a vibrating membrane including a second electrode formed to oppose the first electrode through intermediation of a cavity, the method including: forming a sacrifice layer for forming the cavity and a gap communicating to the cavity via an etching flow path; forming a membrane on a structure having the sacrifice layer, and forming an etching opening portion in the membrane on a region of the sacrifice layer that is to become the gap; forming the cavity by removing the sacrifice layer through the etching opening portion; and forming the sealing portion in a region including the etching opening portion in order to seal the etching opening portion, in which the forming a sacrifice layer includes setting a height of the sacrifice layer in a region that is to become the gap to be smaller than a height of the sacrifice layer in a region that is to become the cavity.

Further features of the present invention will become apparent from the following description of exemplary embodiments with reference to the attached drawings.

### BRIEF DESCRIPTION OF DRAWINGS

FIG. 1A is a view illustrating a capacitive transducer according to an embodiment of the present invention.

FIG. 1B is a view illustrating the capacitive transducer according to the embodiment of the present invention.

FIG. 2 is a view illustrating a capacitive transducer according to another embodiment of the present invention.

FIG. 3A is a cross-sectional view illustrating a sealing portion for sealing a cavity.

FIG. 3B is a cross-sectional view illustrating the sealing portion for sealing the cavity.

FIG. 3C is a cross-sectional view illustrating the sealing portion for sealing the cavity.

FIG. 3D is a cross-sectional view illustrating the sealing portion for sealing the cavity.

FIG. 4A is a view illustrating a method of manufacturing a capacitive transducer according to an embodiment of the present invention.

FIG. 4B is a view illustrating the method of manufacturing the capacitive transducer according to the embodiment of the present invention.

FIG. 4C is a view illustrating the method of manufacturing the capacitive transducer according to the embodiment of the present invention.

FIG. 4D is a view illustrating the method of manufacturing the capacitive transducer according to the embodiment of the present invention.

FIG. 4E is a view illustrating the method of manufacturing the capacitive transducer according to the embodiment of the present invention.

FIG. 4F is a view illustrating the method of manufacturing the capacitive transducer according to the embodiment of the present invention.

FIG. 4G is a view illustrating the method of manufacturing the capacitive transducer according to the embodiment of the present invention.

FIG. 4H is a view illustrating the method of manufacturing the capacitive transducer according to the embodiment of the present invention.

FIG. 4I is a view illustrating the method of manufacturing the capacitive transducer according to the embodiment of the present invention.

FIG. 4J is a view illustrating the method of manufacturing the capacitive transducer according to the embodiment of the present invention.

FIG. 5A is a view illustrating a method of manufacturing a capacitive transducer according to another embodiment of the present invention.

FIG. 5B is a view illustrating the method of manufacturing the capacitive transducer according to another embodiment of the present invention.

FIG. 5C is a view illustrating the method of manufacturing the capacitive transducer according to another embodiment of the present invention.

FIG. 5D is a view illustrating the method of manufacturing the capacitive transducer according to another embodiment of the present invention.

FIG. 5E is a view illustrating the method of manufacturing the capacitive transducer according to another embodiment of the present invention.

FIG. 5F is a view illustrating the method of manufacturing the capacitive transducer according to another embodiment of the present invention.

FIG. 5G is a view illustrating the method of manufacturing the capacitive transducer according to another embodiment of the present invention.

FIG. 5H is a view illustrating the method of manufacturing the capacitive transducer according to another embodiment of the present invention.

FIG. 5I is a view illustrating the method of manufacturing the capacitive transducer according to another embodiment of the present invention.

FIG. 5J is a view illustrating the method of manufacturing the capacitive transducer according to another embodiment of the present invention.

FIG. 5K is a view illustrating the method of manufacturing the capacitive transducer according to another embodiment of the present invention.

FIG. 5L is a view illustrating the method of manufacturing the capacitive transducer according to another embodiment of the present invention.

FIG. 6A is a diagram illustrating an apparatus including the capacitive transducer of the present invention according to an embodiment of the present invention.

FIG. 6B is a diagram illustrating an apparatus including the capacitive transducer of the present invention according to an embodiment of the present invention.

### DESCRIPTION OF EMBODIMENTS

Preferred embodiments of the present invention will now be described in detail in accordance with the accompanying drawings.

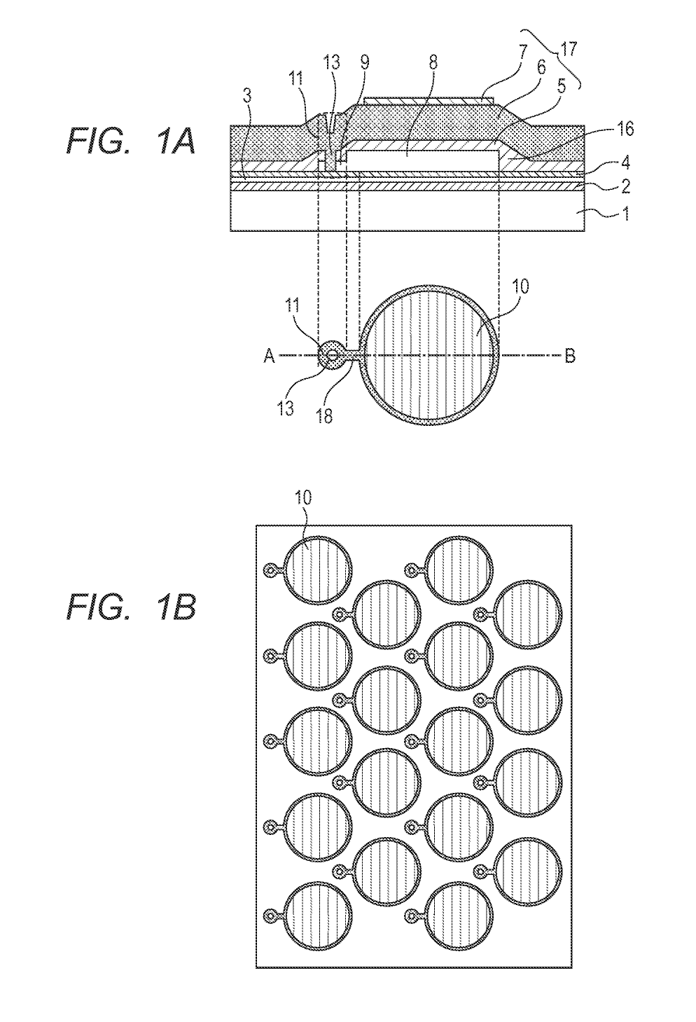

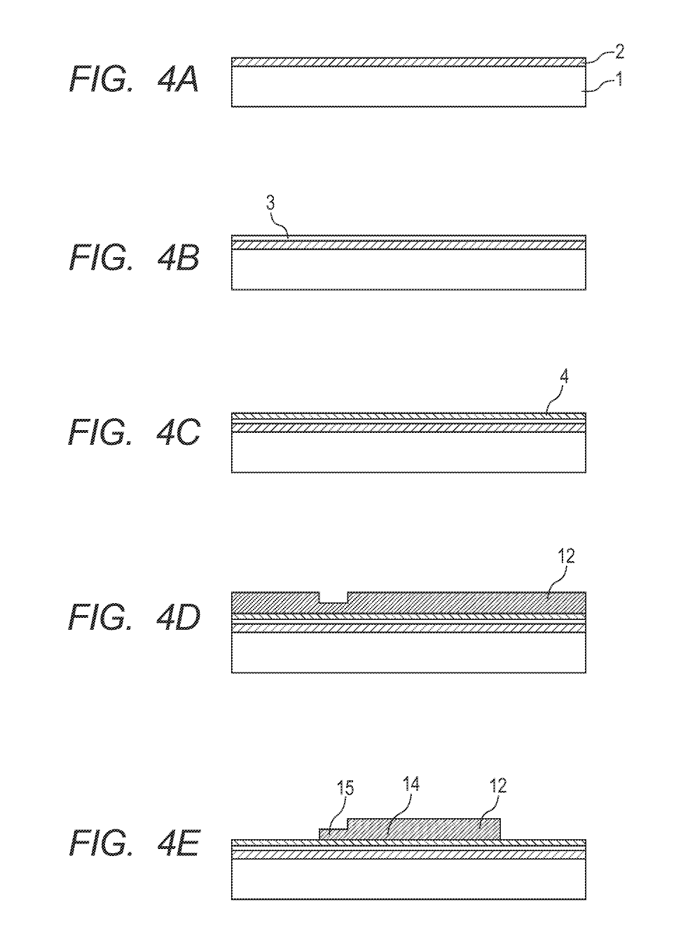

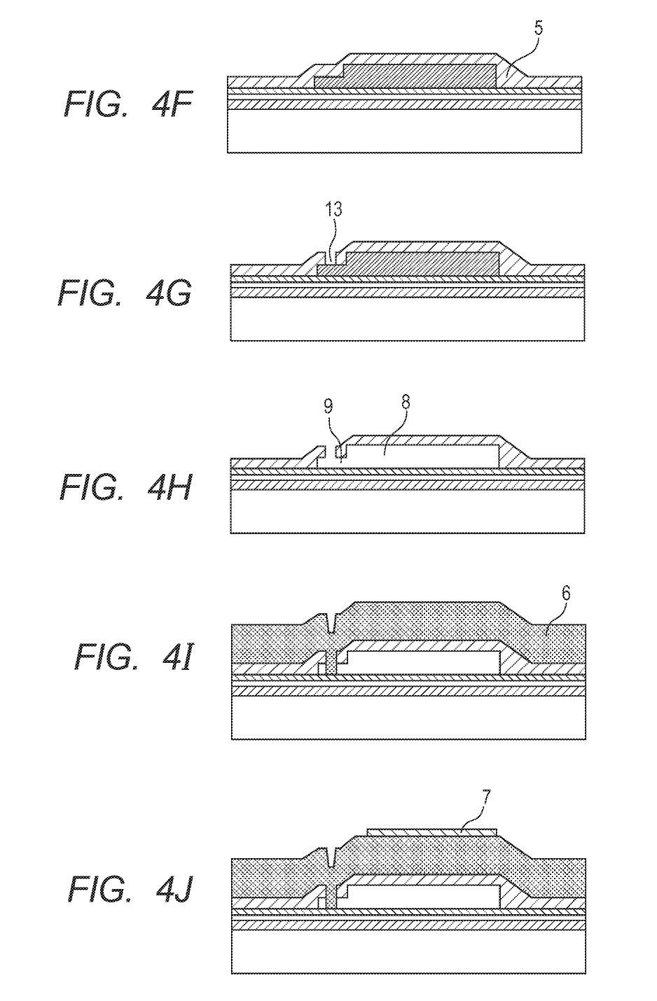

In a capacitive transducer of the present invention, in a state after a sealing portion for sealing an etching opening portion is formed, a height of a gap at a periphery of the sealing portion is smaller than a height of a cavity located under a vibrating membrane. Further, in the middle of a manufacturing method therefor, in a state after a sacrifice layer is formed, a height of the sacrifice layer in a region that is to become a gap communicating to the cavity via an etching flow path is set to be smaller than a height of the sacrifice layer in a region that is to become the cavity. Then, the etching opening portion is formed in a membrane located on the region of the sacrifice layer that is to become the gap. In this case, by sacrifice layer etching, the gap located under the etching opening portion and at its periphery, the etching flow path, and the cavity are formed, and the gap communicates to the cavity via the etching flow path. In other words, the sacrifice layer is formed into a three-dimensional shape including the regions that are to become the gap, the etching flow path, and the cavity, and the membrane is formed on the three-dimensional shape. When viewed from the direction of the height, for example, the three-dimensional shape is such an outer circumferential shape obtained by connecting a large circle and a small circle with a path as illustrated in the lower view of FIG. 1A. When viewed from the horizontal direction, for example, the three-dimensional shape is such a stepped shape as illustrated in FIG. 4E. Further, the “gap at a periphery of the sealing portion” is a space adjacent to the sealing portion, that is, a space included in the gap that is located under the etching opening portion and at its periphery, and formed by sacrifice layer etching. One end of the gap communicates to the etching opening portion, and the other end thereof communicates to the cavity via the etching flow path.

Embodiments of the present invention are described below with reference to the accompanying drawings. An upper view of FIG. 1A is a cross-sectional view taken along the line A-B of a lower view of FIG. 1A that illustrates a capacitive transducer according to an embodiment of the present invention. The lower view of FIG. 1A is a top view of the upper view of FIG. 1A. Only one cell 10 is illustrated in each of the upper and lower views of FIG. 1A, but any number of cells 10 may be formed in the transducer as illustrated in a top view of FIG. 1B. Further, the cells 10 may be arranged in any manner without being limited to the arrangement illustrated in FIG. 1B. As illustrated in FIGS. 1A and 1B, a vibrating membrane 17 of the transducer according to this embodiment has a circular planar shape, but the planar shape may be rectangular, hexagonal, or the like.

A configuration of the capacitive transducer is now described. The transducer includes a substrate 1 made of Si or the like, an insulating film 2 formed on the substrate 1, a first electrode (lower electrode) 3 formed on the insulating film 2, and an insulating film 4 formed on the first electrode 3. On the insulating film 4, the vibrating membrane 17 including a first membrane 5, a second membrane 6, and a second electrode (upper electrode) 7 is formed through the intermediation of a cavity 8. The first membrane is supported by a vibrating membrane support portion 16. When the substrate 1 is an insulator such as a glass substrate, the insulating film 2 may be omitted.

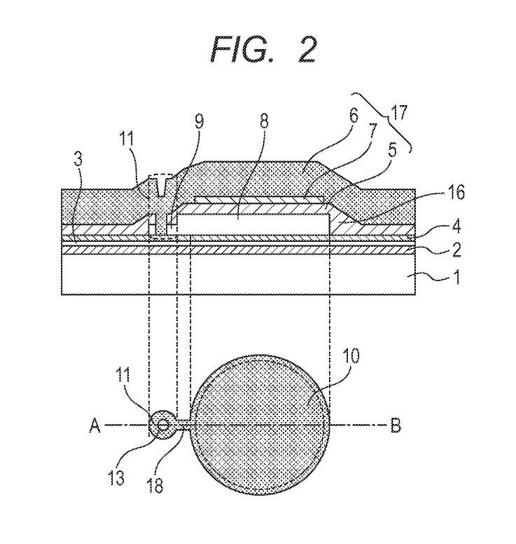

Further, in FIGS. 1A and 1B, the second electrode 7 opposing the first electrode 3 is arranged on a surface of the second membrane 6, but the second electrode 7 may be arranged between the first membrane 5 and the second membrane 6 as illustrated in the upper view of FIG. 2. In other words, the second electrode 7 may be arranged inside the vibrating membrane 17. The configuration illustrated in FIG. 2 can reduce a distance between the first electrode 3 and the second electrode 7, to thereby increase the capacitance of the transducer to improve its performance. The transducer further includes a voltage applying unit configured to apply a voltage between the first electrode 3 and the second electrode 7.

Ultrasonic waves can be transmitted and received by generating vibration of the vibrating membrane 17 in a state in which the voltage is applied between the first electrode 3 and the second electrode 7. The drive principle is as follows. The cell 10 includes the first electrode 3 and the second electrode 7 that are formed to sandwich the cavity 8. For reception of an acoustic wave, a DC voltage is applied to the first electrode or the second electrode. When the acoustic wave is received, the vibrating membrane 17 is deformed to change a gap of the cavity 8, to thereby change the capacitance between the electrodes. Through detection of the change in capacitance from the first electrode or the second electrode, the acoustic wave can be detected. On the other hand, by applying an AC voltage to the first electrode or the second electrode to vibrate the vibrating membrane 17, an acoustic wave can also be transmitted. The capacitive transducer illustrated in FIGS. 1A and 1B can convert an acoustic wave signal into an electric signal or convert an electric signal into an acoustic wave signal via a lead-out wire extending from the upper electrode or a lead-out wire extending from the lower electrode. Instead of using the lead-out wire, a through wire or the like may be used.

The cavity or a gap of the capacitive transducer is formed by arranging a sacrifice layer in advance in a region that is to become the cavity or the gap and performing sacrifice layer etching to remove the sacrifice layer through an etching opening portion opened in the membrane. Specifically, a sacrifice layer 12 is formed in a region located under the vibrating membrane in which the cavity 8 is to be formed and in a region located in the vicinity of the etching opening portion in which a gap 9 is to be formed (the latter region includes a region that is to become a sealing portion and a region that is to become a gap at a periphery of the sealing portion in a subsequent step) (see FIGS. 4A to 4J). The sacrifice layer 12 includes a region in which an etching flow path 18 that connects the gap 9 formed in the vicinity of the etching opening portion and the cavity 8 to each other is to be formed. Then, after the first membrane 5 and the vibrating membrane support portion 16 are formed on the sacrifice layer 12, an etching opening portion 13 for removing the sacrifice layer 12 is formed in a region of the first membrane 5 located above the gap 9. By removing the sacrifice layer 12 through the etching opening portion 13 by sacrifice layer etching, the gap 9, the cavity 8, and a gap including the etching flow path 18 are formed. After those gaps are formed, a sealing film serving also as the second membrane 6 is deposited on the etching opening portion 13, to thereby form a sealing portion 11 for sealing the etching opening portion 13. Among the materials forming the capacitive transducer, in particular, the material forming the cavity 8 is preferred to have a small surface roughness so that the vibrating membrane may not contact with a bottom surface of the cavity 8 when the vibrating membrane vibrates.

In order to realize stable and easy formation of the sealing portion 11 for sealing the etching opening portion 13, it is preferred that the width (dimension in a direction parallel to an in-plane direction of the substrate) of the etching flow path adjacent to the region in which the etching opening portion is formed be larger than the width of the etching opening portion. Further, it is preferred that the width of the etching opening portion be as small as possible because the cells can be arranged more closely. Specifically, when projected onto the substrate by orthographic projection, the dimensions of the etching flow path adjacent to the region in which the etching opening portion is formed are larger than the dimensions of the etching opening portion when projected onto the substrate by orthographic projection. Further, when the cross-sectional shape (cross-sectional shape in a plane perpendicular to a direction of the height) of the structure located in the vicinity of the etching opening portion is a rotationally symmetric shape (for example, a circle), the sealing can be stably and easily realized to improve yield. Specifically, as compared to the case where the cross-sectional shape of the structure located in the vicinity of the etching opening portion is not rotationally symmetric, inflow conditions such as gas for CVD or the like and etchant become uniform so that sealing conditions become uniform irrespective of directions, and hence a sealing defect does not easily occur. In this manner, it is preferred that the cross-sectional shape of the gap located at the periphery of the sealing portion in the plane perpendicular to the direction of the height be rotationally symmetric. Note that, if the width of the etching flow path is excessively large, the strength of the vibrating membrane support portion is reduced, and hence it is preferred that the etching flow path have an appropriate width larger than the width of the etching opening portion. For example, the width of the etching flow path is set so that the width of the gap located at the periphery of the sealing portion may be larger than the width of the etching flow path. The height of the etching flow path less affects the easiness of sealing, and hence it is preferred that the height of the etching flow path be approximately the same as that of the cavity 8 in order to facilitate the flow of the etchant.

For the first electrode 3, materials such as titanium, aluminum, and molybdenum can be used. In particular, titanium is preferred because titanium has a small roughness change caused by influence of heat applied during a process and has a high etching selectivity with respect to the sacrifice layer material and the material forming the vibrating membrane. For the insulating film 4, an oxide silicon film or the like can be used. In particular, an oxide silicon film formed by a PE-CVD apparatus has a small surface roughness and can be formed at a low temperature of 400° C. or less, and hence the influence of heat for other constituent materials can be reduced. The first membrane 5 and the second membrane 6 of the vibrating membrane 17 and the vibrating membrane support portion 16 are insulating films. In particular, a nitride silicon film formed by a PE-CVD apparatus can be formed at a low temperature of 400° C. or less, and hence the influence of heat for other constituent materials can be reduced. Further, the film can be formed with a low tensile stress of 300 MPa or less, and hence a large deformation of the vibrating membrane caused by residual stress of the membrane can be prevented.

Further, the second membrane 6 needs to seal the gap by being deposited in and on the etching opening portion 13, as well as to function as the vibrating membrane. As the material for sealing the gap, in order to seal the gap by being deposited in and on the etching opening portion 13, the material is desired to have high coverage performance and to prevent the sealing film from entering the inside of the cavity 8 located under the vibrating membrane from the etching opening portion 13 via the etching flow path 18. This is because, if the sealing film enters the inside of the cavity 8, the height of the cavity 8 changes to affect transducer performance. For example, a nitride silicon film formed by LP-CVD is highly likely to enter the inside of the cavity via the etching flow path 18, and therefore has a risk of changing the thickness of the cavity. As the material satisfying those conditions of the sealing film, a nitride silicon film formed by PE-CVD is preferred.

As the material of the sacrifice layer 12 for forming the gap or the cavity, it is preferred to select a material that can be relatively easily removed in the sacrifice layer etching step and has a sufficiently high etching selectivity with respect to other constituent materials. In addition, it is preferred to select a material that less affects the roughness of the membrane even in a thermal step for forming the membrane. As the material satisfying those requirements, for example, metals, such as chromium and molybdenum, and amorphous silicon can be selected. In particular, chromium can easily be etched by a mixed solution of ceric ammonium nitrate and perchloric acid, and has the following feature. That is, chromium has a sufficiently high etching selectivity with respect to titanium as the material of the first electrode 3, oxide silicon as the material of the insulating film 4, and a nitride silicon film as the material of the membrane, which are the constituent materials present in the sacrifice layer etching step. Consequently, in the sacrifice layer etching step, the gap and the cavity can be formed while suppressing damage to the materials other than the sacrifice layer.

Further, the sacrifice layer is formed of the region of the cavity 8, which is a gap in a region where the vibrating membrane vibrates, the region of the gap 9 located under the etching opening portion and at its periphery, through which a sacrifice layer removal solution enters when the sacrifice layer etching is performed, and the region of the etching flow path 18 that connects those regions. The heights of the respective regions are set as follows. The cavity 8 corresponds to the region where the vibrating membrane vibrates, and hence the height of the cavity 8 is set in accordance with design specifications. The region of the gap 9 located under the etching opening portion and at its periphery and the region of the etching flow path 18 are required to allow the etchant for removing the sacrifice layer to infiltrate the gap in the sacrifice layer etching step, and hence a lower limit value of the heights of the regions is determined based on the film thickness that enables the sacrifice layer etching. The lower limit value varies depending on the material of the sacrifice layer and the solvent for removing the sacrifice layer, and hence is not determined to be a unique value. However, in the case where the sacrifice layer is made of chromium and the sacrifice layer etching is performed with a solution containing ceric ammonium nitrate and perchloric acid, the height of the sacrifice layer may be 100 nm or less (for example, approximately 80 nm). Specifically, in order to achieve good sealing property, the height of the gap located in the vicinity of the etching opening portion (that is, the height of the sacrifice layer located under the etching opening portion and at its periphery) needs to be reduced, but there is a limit to reduce the height. The lower limit value is determined based on the height that enables infiltration of etchant having a given viscosity. The above-mentioned etchant has a low viscosity, but if the height is excessively small (for example, 50 nm or less), there is a risk in that the etchant cannot enter the inside of the cavity. However, when gas is used as the etchant, the height can be further reduced.

The second electrode 7 is the material forming a part of the vibrating membrane 17, and hence the second electrode 7 needs to be made of a material having a relatively small stress. For example, titanium, aluminum, or the like can be used.

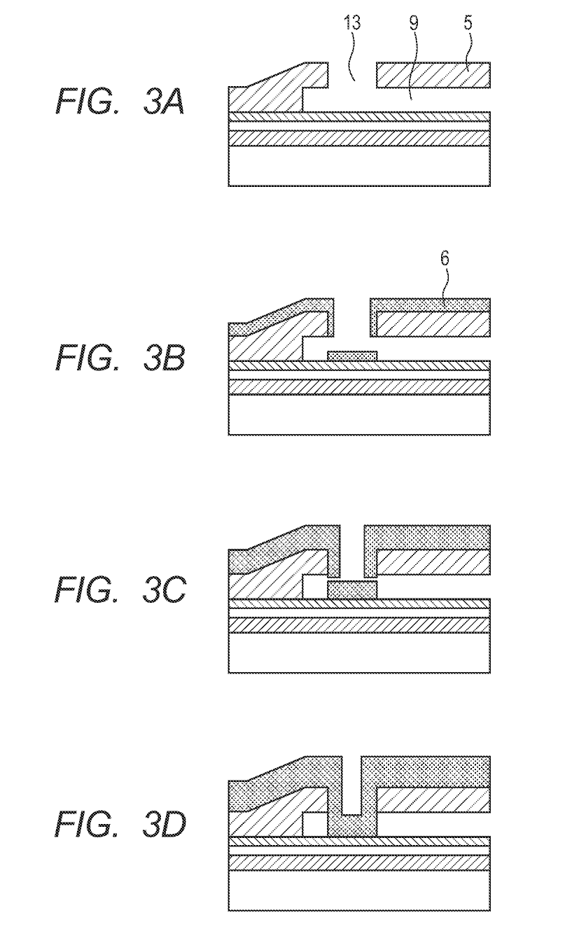

Referring to FIGS. 3A to 3D, the step of depositing a sealing film in and on the etching opening portion 13 to seal the etching opening portion 13 after the gap and the cavity are formed by sacrifice layer etching is described below. FIGS. 3A to 3D illustrate the course of sealing the gap by depositing a sealing film made of the second membrane 6 in and on the etching opening portion 13 after the sacrifice layer 12 is removed by sacrifice layer etching. When a film is formed in the etching opening portion 13 by PE-CVD, the film is deposited on a bottom surface of the etching opening portion 13 and on a side surface and a top surface of the first membrane 5 in which the etching opening portion 13 is opened (FIGS. 3A to 3C). The film deposited on the bottom surface of the etching opening portion 13 and the film deposited on the side surface of the first membrane 5 are connected to each other to be a continuous film, to thereby seal the etching opening portion (FIG. 3D). At this time, the film necessary for the sealing depends on the height of the gap in the region in which the etching opening portion is formed, specifically, the height three times as large as the height of the gap is necessary. In the capacitive transducer of the present invention, the height of the cavity 8 located under the vibrating membrane and the height of the gap 9 located under the etching opening portion and at its periphery are different from each other, and the height of the gap 9 is smaller than the height of the cavity 8. In this case, the sealing thickness necessary for sealing the gap portion of the capacitive transducer is determined based not on the height of the cavity 8 but on the height of the gap 9 located in the vicinity of the etching opening portion for removing the sacrifice layer. Consequently, by setting the height of the gap 9 to be smaller than the height of the cavity 8, the sealing thickness necessary for sealing the gap portion can be reduced without changing the height of the cavity 8 that affects the performance, and hence the reliability of sealing is improved.

The cavity located under the vibrating membrane of the capacitive transducer corresponds to the region where the vibrating membrane vibrates to transmit and receive an ultrasonic wave, and hence the height of the cavity greatly affects its performance. For example, in the case of vibrating the vibrating membrane to transmit an ultrasonic wave, it is necessary to increase a vibration displacement of the vibrating membrane in order to increase the sound pressure of an ultrasonic wave to be transmitted. In general, the vibrating membrane is used under a condition that the vibrating membrane does not contact with the bottom surface of the cavity, and hence it is necessary to increase the height of the cavity in order to increase the vibration displacement of the vibrating membrane. However, in order to seal the gap portion, it is necessary to deposit a sealing film whose thickness is approximately three times as large as the thickness of the gap portion. Accordingly, in the related-art, in terms of design, when the height of the cavity is increased, a thicker sealing film needs to be formed in order to seal the gap portion, and hence the sealing becomes difficult to decrease the reliability of sealing.

The capacitive transducer of the present invention is applicable to an object information acquiring apparatus using acoustic waves. The transducer receives an acoustic wave from an object, and the object information acquiring apparatus can use an output electric signal to acquire object information that reflects an optical characteristic value of the object, such as a light absorption coefficient, object information that reflects a difference in acoustic impedance, and other such information. More specifically, an object information acquiring apparatus according to an embodiment of the present invention irradiates the object with light (electromagnetic wave including a visible ray or an infrared ray). The transducer receives a photoacoustic wave that is generated at multiple positions (sites) in the object as a result of the irradiation of light, and the object information acquiring apparatus acquires a characteristic distribution representing the distribution of characteristic information corresponding to the respective multiple positions in the object. The characteristic information to be acquired by a photoacoustic wave relates to absorption of light, and includes characteristic information that reflects an initial sound pressure of the photoacoustic wave generated by light irradiation, or a light energy absorption density, an absorption coefficient, a concentration of a substance of a tissue, or the like, which is derived from the initial sound pressure. The concentration of a substance is, for example, the degree of oxygen saturation, a total hemoglobin concentration, an oxyhemoglobin concentration, or a deoxyhemoglobin concentration. Further, the object information acquiring apparatus can also be used for the purpose of diagnosis of human or animal malignant tumor and vascular disease, follow-up of chemical treatment, and the like. Accordingly, an assumable object is a living body, specifically, a subject of diagnosis such as human or animal breast, neck, and abdomen. A light absorber located inside the object is a tissue having a relatively high absorption coefficient inside the object. For example, when an object is a part of a human body, the light absorber is oxyhemoglobin, deoxyhemoglobin, or a blood vessel containing a large amount of such hemoglobin, a tumor containing a large amount of neovascular vessels, a plaque on the carotid wall, or the like. In addition, a molecular probe specifically binding to a malignant tumor and a capsule for delivering a medicament by using gold particles, graphite, or the like are also the light absorbers.

Further, without being limited to the reception of a photoacoustic wave, the object information acquiring apparatus can receive a reflected wave due to an ultrasonic echo obtained when an ultrasonic wave transmitted from a probe including the transducer is reflected inside the object, to thereby also acquire a distribution relating to acoustic characteristics inside the object. The distribution relating to acoustic characteristics includes a distribution that reflects a difference in acoustic impedance of a tissue inside the object. However, the transmission and reception of the ultrasonic wave and the acquisition of the distribution relating to the acoustic characteristics are not essential.

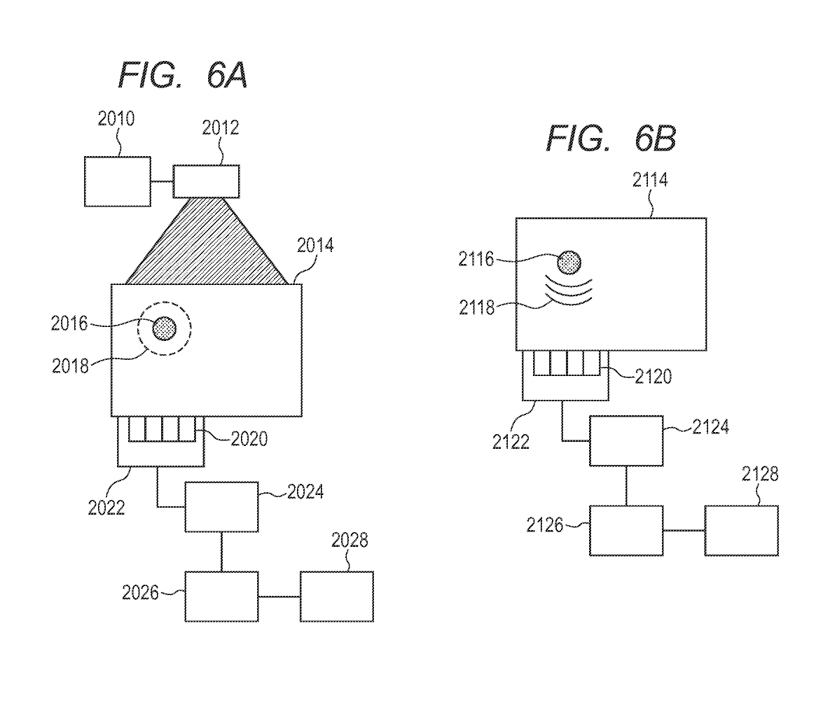

FIG. 6A illustrates an object information acquiring apparatus using a photoacoustic effect. Pulsed light oscillated from a light source 2010 irradiates an object 2014 via an optical member 2012 such as a lens, a mirror, and an optical fiber. A light absorber 2016 inside the object 2014 absorbs energy of the pulsed light to generate a photoacoustic wave 2018 as an acoustic wave. A capacitive transducer 2020 of the present invention included in a probe 2022 receives the photoacoustic wave 2018 to convert the photoacoustic wave 2018 into an electric signal, and outputs the electric signal to a signal processor 2024. The signal processor 2024 subjects the input electric signal to signal processing such as A/D conversion and amplification, and outputs the resultant signal to a data processor 2026. The data processor 2026 uses the input signal to acquire object information (characteristic information that reflects an optical characteristic value of the object, such as a light absorption coefficient) as image data. In this case, the signal processor 2024 and the data processor 2026 are collectively referred to as processor. A display unit 2028 displays an image based on the image data input from the data processor 2026.

FIG. 6B illustrates an object information acquiring apparatus using reflection of an acoustic wave, such as an ultrasonic echo diagnostic apparatus. An acoustic wave transmitted from a capacitive transducer 2120 of the present invention included in a probe 2122 to an object 2114 is reflected by a reflector 2116. The transducer 2120 receives a reflected acoustic wave (reflected wave) 2118 to convert the acoustic wave 2118 into an electric signal, and outputs the electric signal to a signal processor 2124. The signal processor 2124 subjects the input electric signal to signal processing such as A/D conversion and amplification, and outputs the resultant signal to a data processor 2126. The data processor 2126 uses the input signal to acquire object information (characteristic information that reflects a difference in acoustic impedance) as image data. Also in this case, the signal processor 2124 and the data processor 2126 are collectively referred to as processor. A display unit 2128 displays an image based on the image data input from the data processor 2126.

Note that, the probe may be configured to scan mechanically or may be configured to be moved by a user, such as a doctor and a technician, relative to the object (handheld type). Further, in the case of the apparatus using the reflected wave as illustrated in FIG. 6B, a probe for transmitting an acoustic wave may be provided separately from a probe for receiving the acoustic wave. In addition, the apparatus may be configured to have both the functions of the apparatuses of FIGS. 6A and 6B so as to acquire both the object information that reflects an optical characteristic value of the object and the object information that reflects a difference in acoustic impedance. In this case, the transducer 2020 of FIG. 6A may be configured not only to receive a photoacoustic wave but also to transmit an acoustic wave and receive a reflected wave.

Now, more specific examples are described.

### EXAMPLE 1

FIGS. 4A to 4J illustrate Example 1 of a method of manufacturing a capacitive transducer according to the present invention. FIGS. 4A to 4J illustrate a process flow of Example 1. In Example 1, a description is given of a method of manufacturing a capacitive transducer including only one cell 10, however, any number of cell structures may be formed. Further, FIGS. 4A to 4J illustrate a structure in which one cell 10 has one etching opening portion, but any number of etching opening portions may be formed in one cell 10. In addition, one etching opening portion may be formed in multiple cells 10. Also in this case, in a state in which the sealing portion is formed, the height of the gap at the periphery of the sealing portion that seals one etching opening portion formed for forming multiple cavities by sacrifice layer etching is smaller than the heights of the multiple cavities. Further, in a state immediately after the sacrifice layer is formed, the height of the sacrifice layer in a region that is to become a gap located in the vicinity of the region in which one etching opening portion is to be formed is smaller than the height of the sacrifice layer in regions that are to become the multiple cavities.

The capacitive transducer of Example 1 includes the silicon substrate 1 having a thickness of 300 μm, the insulating film 2 made of a thermal oxide film and formed on the substrate 1, the first electrode 3 made of titanium and formed on the insulating film 2, and the insulating film 4 made of a silicon oxide film and formed on the first electrode 3. The capacitive transducer further includes the cell 10 including the cavity formed between the first electrode 3 and the second electrode 7, the vibrating membrane 17 formed above the cavity, and the vibrating membrane support portion 16 for supporting the vibrating membrane 17. The vibrating membrane 17 includes the first membrane 5 formed above the cavity, the second membrane 6 for sealing the cavity, and the second electrode 7. The capacitive transducer further includes the voltage applying unit configured to apply a voltage between the first electrode 3 and the second electrode 7.

The gap portion of the capacitive transducer of Example 1 is formed by performing a sacrifice layer etching step illustrated in FIGS. 4A to 4H. First, the insulating film 2 made of a thermal oxide film, the first electrode 3 made of titanium, and the insulating film 4 made of a silicon oxide film are formed on the silicon substrate 1. Next, a chrome film as a sacrifice layer material having a thickness of 200 nm is formed on the insulating film 4. Photolithography and dry etching using Cl₂ gas are performed to etch a region in which an etching opening portion for removing the sacrifice layer 12 is to be formed, to thereby set the thickness in the region to 80 nm (FIG. 4D). Next, photolithography and dry etching using Cl₂ gas are performed for patterning so as to leave a sacrifice layer 15 in a region that is to become the etching opening portion and a sacrifice layer 14 in a region that is to become a vibrating portion and a flow path (FIG. 4E). Through the steps described above, the structure in which the height of the gap varies between the region of the etching opening portion and the region of the vibrating portion and the flow path can be formed.

Next, by using a PE-CVD apparatus, a silicon nitride film to become the first membrane 5 and the vibrating membrane support portion 16 is formed to have a thickness of 400 nm on the structure having the sacrifice layer 12 (FIG. 4F). Next, the first membrane 5 is patterned by photolithography and dry etching using CF₄ gas, to thereby form the etching opening portion 13 (FIG. 4G). Next, a solution containing ceric ammonium nitrate and perchloric acid is introduced through the etching opening portion 13 to remove the sacrifice layer 12, to thereby form a gap including the cavity 8 serving as a vibrating portion and the gap 9 in the vicinity of the etching opening portion (FIG. 4H). Then, by using the PE-CVD apparatus, a silicon nitride film to become the second membrane 6 is formed to have a thickness of 300 nm on the etching opening portion 13. Through this step, the gap portion is sealed at the etching opening portion 13 (FIG. 4I). Finally, the second electrode 7 is formed on the second membrane 6 (FIG. 4J).

In Example 1, the height of the sacrifice layer 12 varies between a region in the vicinity of the etching opening portion 13 and a region of the vibrating portion: the former is 80 nm and the latter is 200 nm. The thickness of the film necessary for sealing the gap needs to be approximately three times as large as the thickness of the gap. Accordingly, in the related-art configuration in which the height of the cavity located under the vibrating membrane is the same as the height of the gap located in the vicinity of the etching opening portion 13, the sealing of the cavity needs a sealing thickness of approximately 600 nm, which is three times as large as the height of 200 nm of the gap located in the vicinity of the etching opening portion 13. In the configuration of Example 1, the sealing thickness necessary for the sealing is three times as large as the height of 80 nm of the gap located in the vicinity of the etching opening portion 13, that is, approximately 240 nm. Consequently, the thickness of the sealing film necessary for sealing the cavity can be reduced to improve sealing performance for the cavity.

### EXAMPLE 2

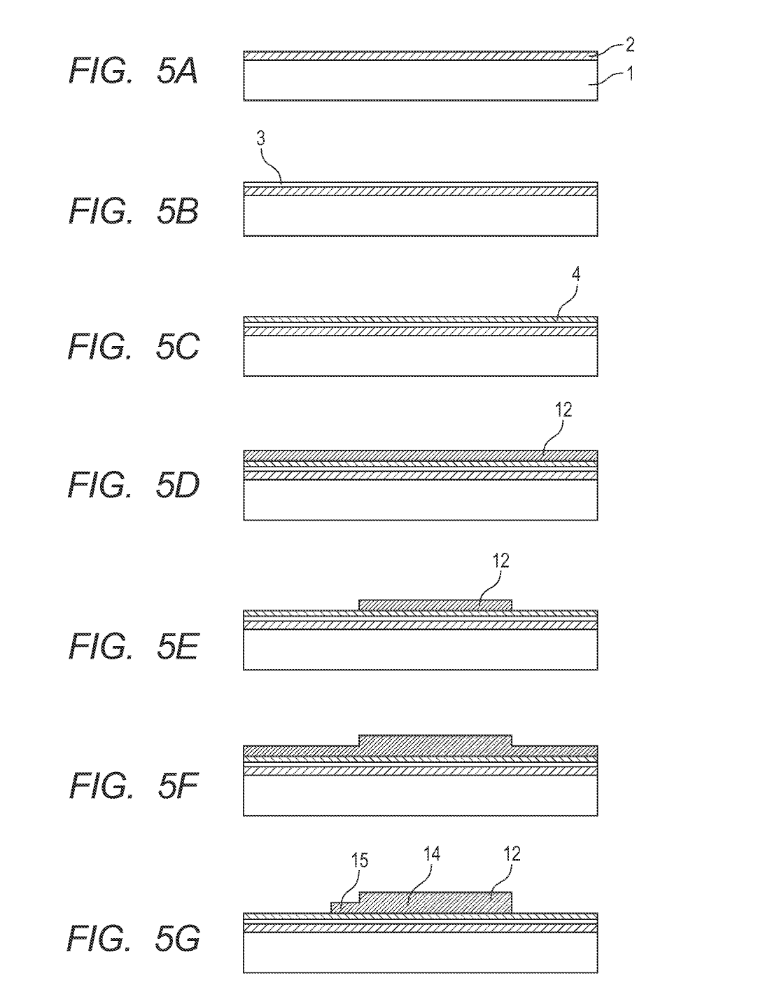

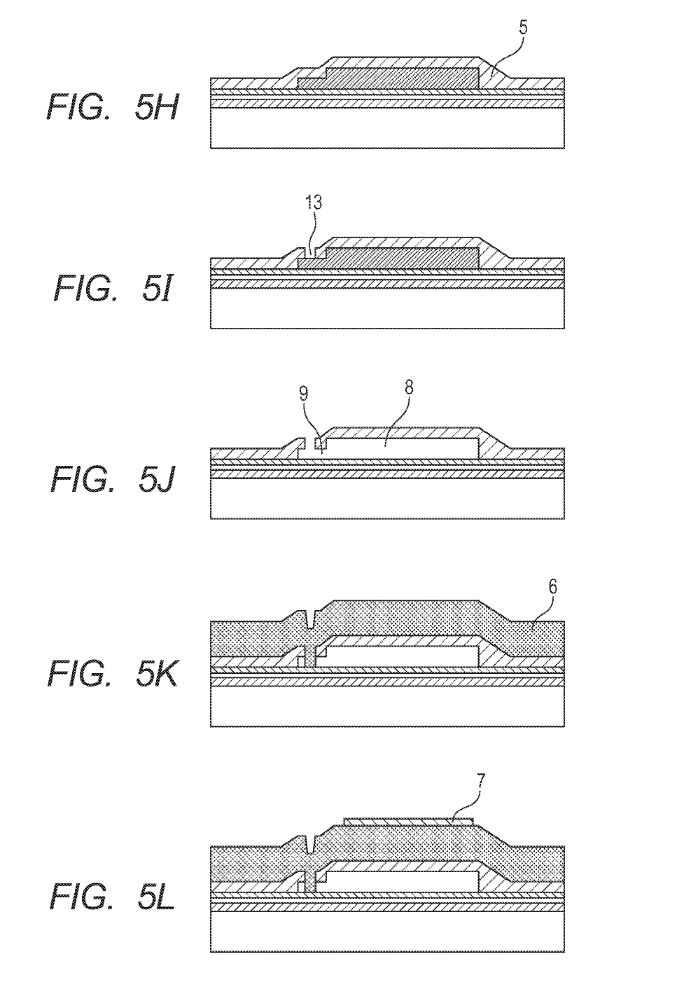

Example 2 of a method of manufacturing a capacitive transducer having the structure of the present invention is described with reference to FIGS. 5A to 5L. Example 2 differs from Example 1 in a method of forming a sacrifice layer whose height varies depending on regions. Similarly to Example 1, an insulating film 2, a first electrode 3, and an insulating film 4 are formed on a silicon substrate 1 (FIGS. 5A to 5C), and then a chrome film to become a sacrifice layer having a thickness of 150 nm is formed on the insulating film 4 (FIG. 5D). Next, patterning is performed by photolithography and wet etching so as to leave a sacrifice layer only in a region that is to become a cavity located under a vibrating membrane (FIG. 5E). Next, a chrome film to become a sacrifice layer is formed again to have a thickness of 50 nm (FIG. 5F). Next, patterning is performed by photolithography and wet etching so as to leave a sacrifice layer 14 in a region that is to become the cavity located under the vibrating membrane and a flow path and a sacrifice layer 15 in a region in the vicinity of an etching opening portion (FIG. 5G).

After that, similarly to Example 1, a membrane 5 and an etching opening portion 13 are formed, and a gap 9 and a cavity 8 are formed by sacrifice layer etching. After that, the etching opening portion 13 is sealed to manufacture a capacitive transducer (FIGS. 5H to 5L).

The height of the sacrifice layer 15 in the region in the vicinity of the etching opening portion has a relation to the sealing thickness, and hence it is preferred to control the height accurately. In Example 1, the height of the sacrifice layer 15 in the region in the vicinity of the etching opening portion is determined by control of the duration of dry etching. This method involves the control of the duration, and hence it cannot be said that the height can be easily controlled accurately. In Example 2, the step of forming the sacrifice layer 12 is divided into two steps. This can accurately control the height of the sacrifice layer 15 in the region in the vicinity of the etching opening portion. Consequently, the sealing thickness necessary for sealing the etching opening portion 13 can be determined with good controllability based on the height of the sacrifice layer 15 in the region in the vicinity of the etching opening portion, and hence the reliability of sealing is further improved.

### INDUSTRIAL APPLICABILITY

According to one embodiment of the present invention, the heights of the gaps located under the etching opening portion and at its periphery are smaller than the height of the cavity located under the vibrating membrane. According to this structure, the height of the sealing portion necessary for sealing the cavity is determined based on the height of the gap in the vicinity of the etching opening portion, and hence, even with a structure in which a cavity having the same height as hitherto is located under the vibrating membrane, the height of the sealing portion necessary for sealing the cavity is reduced. Consequently, the cavity can be sealed with a sealing portion thinner than hitherto, and the sealing can be facilitated, and hence the reliability of sealing is improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-120666, filed Jun. 7, 2013, which is hereby incorporated by reference herein in its entirety.

### REFERENCE SIGNS LIST

1: substrate, 3: first electrode, 5, 6: membrane, 7:

second electrode, 8: cavity, 9: gap located in vicinity of etching opening portion (gap at periphery of sealing portion), 10: cell, 12: sacrifice layer, 13: etching opening portion, 14: sacrifice layer in region that is to become cavity located under vibrating membrane, 15: sacrifice layer in region in vicinity of etching opening portion (sacrifice layer in region that is to become gap), 17: vibrating membrane, 18: etching flow path

1. A capacitive transducer, comprising:
a cell including:
a first electrode, and
a vibrating membrane comprising a second electrode, the second electrode being formed to oppose the first electrode through intermediation of a cavity; and
a sealing portion for sealing an etching opening portion, the etching opening portion being formed by sacrifice layer etching in order to form the cavity,
wherein a gap at a periphery of the sealing portion has a height smaller than a height of the cavity.

2. The capacitive transducer according to claim 1, further comprising an etching flow path formed to communicate the cavity and the gap at the periphery of the sealing portion with each other,
wherein the gap at the periphery of the sealing portion has a width larger than a width of the etching flow path.

3. The capacitive transducer according to claim 1, wherein a cross-sectional shape of the gap at the periphery of the sealing portion in a plane perpendicular to a direction of the height comprises a rotationally symmetric shape.

4. The capacitive transducer according to claim 1, wherein the second electrode is arranged inside the vibrating membrane.

5. The capacitive transducer according to claim 1, wherein the second electrode is arranged on a surface of the vibrating membrane.

6. A method of manufacturing a capacitive transducer, the capacitive transducer comprising a cell and a sealing portion, the cell comprising a first electrode and a vibrating membrane including a second electrode formed to oppose the first electrode through intermediation of a cavity,
the method comprising:
forming a sacrifice layer for forming the cavity and a gap communicating with the cavity via an etching flow path;
forming a membrane on a structure having the sacrifice layer, and forming an etching opening portion in the membrane on a region of the sacrifice layer that is to become the gap;
forming the cavity by removing the sacrifice layer through the etching opening portion; and
forming the sealing portion in a region including the etching opening portion in order to seal the etching opening portion,
wherein the forming a sacrifice layer comprises setting a height of the sacrifice layer in a region that is to become the gap to be smaller than a height of the sacrifice layer in a region that is to become the cavity.

7. The method according to claim 6, wherein the forming of the sacrifice layer further comprises setting a width of the sacrifice layer in the region that is to become the gap to be larger than a width of the sacrifice layer in a region that is to become the etching flow path.

8. The method according to claim 6, wherein the forming of the sacrifice layer further comprises forming a cross-sectional shape of the sacrifice layer in the region that is to become the gap in a plane perpendicular to a direction of the height to be a rotationally symmetric shape.

9. An object information acquiring apparatus, comprising:
the capacitive transducer according to claim 1; and
a processor configured to acquire information on an object by using an electric signal output from the capacitive transducer,
wherein the capacitive transducer is configured to receive an acoustic wave from the object and output the electric signal.

10. An object information acquiring apparatus, comprising:
the capacitive transducer according to claim 1;
a light source; and
a data processing device,
wherein the capacitive transducer is configured to receive an acoustic wave generated by light that is oscillated from the light source to irradiate an object, and convert the received acoustic wave into an electric signal, and
wherein the data processing device is configured to acquire information on the object by using the electric signal.
